(19) United States
(12) Patent Application Publication
(10) Pub. No.: US 2026/0238007 A1
(43) Pub. Date: Aug. 13, 2026

(54) METHOD FOR CONTROLLING AN ENERGY STORAGE FACILITY

(71) Applicant: CORRE ENERGY B.V., Groningen (NL)

(72) Inventors: Franz ZEHNER, Groningen (NL); Keith MCGRANE, Groningen (NL); Hans-Age NIELSEN, Groningen (NL)

(21) Appl. No.: 19/153,545

(22) PCT Filed: Feb. 5, 2024
(86) PCT No.: PCT/EP2024/052751

§ 371 Date: Aug. 4, 2025

(30) Foreign Application Priority Data
Feb. 6, 2023 (GB) 2301642.1

(51) Int. Cl. H02J 3/00; H02J 3/32; H02J 3/38; H02J 3/466; H02J 101/22; H02J 101/28

(52) U.S. Cl. CPC H02J 3/003; H02J 3/004; H02J 3/32; H02J 3/381; H02J 3/466; H02J 2101/22; H02J 2101/28

(57) ABSTRACT

A method is provided for controlling an energy storage facility. The method includes receiving a planned net energy output for a current time period based on a forecast energy demand value for the current time period; receiving a current energy demand value for the current time period; receiving a future energy capacity table comprising, for each of a plurality of future time periods, a forecast energy demand value and a planned net energy adjustment capacity; determining a difference between a current energy demand value and a forecast energy demand value for the current time period; and determining an adjustment to the planned net energy output for the current time period based on the difference between the current energy demand value and the forecast energy demand value for the current time period and the future energy capacity table.

The invention relates to a method for controlling an energy storage facility. In particular, the invention provides a method of adjusting a planned net energy output based on current and forecast energy demand. A future energy capacity table is provided in the method. This enables adjustments to the planned net energy output for a current time period to be balanced with adjustments in net energy output for a plurality of future time periods.

### BACKGROUND

Renewable energy sources such as wind and solar power are increasingly relied upon to supply energy to the grid due to the need to reduce fossil fuel consumption and related emissions. These renewable sources are variable by nature. For example, during periods of high winds wind turbines can produce large amounts of power, which can be in excess of the demand at that time.

During periods of low winds, which may or may not coincide with periods of high demand for electricity, wind turbines may not produce enough power to meet the demand.

Energy storage facilities can be used to store energy harnessed from renewable sources. During periods of high electricity production excess energy can be stored. During periods of low electricity production, or high demand, the stored energy can be used to produce further electricity to supply to the grid.

Various energy storage solutions can be implemented to store surplus energy. Many of these solutions can only store the scale of energy required to balance the grid for a relatively the small period of time. For example, battery storage is useful but can be difficult to scale up to the size required for grid balancing a grid over longer time periods—e.g. during periods with low wind and solar power generation. It is desirable to increase the duration of the energy storage, known as long duration energy storage (LDES). LDES can allow energy to be stored and then released over a prolonged period, advantageously allowing supply to be provided even during several hours or days of decreased production. Compressed air energy storage (CAES) is one solution that can be used to store the excess energy available during periods of high production and to harness that energy during periods of low production or high demand to produce electricity. Typical CAES systems use a compressor during periods of excess production to compress air. The compressed air is stored in an underground cavern. When there is demand, the compressed air is drawn from the cavern and expanded through expansion turbines, to produce power for the grid. Other forms of LDES include pumped hydroelectric, hydrogen and liquid air storage systems.

In each case, an energy storage facility will store energy by performing work to convert electrical energy (usually from an electricity grid) into a form of potential energy. At a later date, this potential energy can then be converted back into electrical energy, and, for example, fed back into the electricity grid. When an energy facility system has converted all of the (usable) potential energy of the system into electrical energy, the energy storage facility is empty and cannot produce any further electrical energy. Similarly, when storing energy, at some point the energy storage facility will reach the maximum potential energy it can store, at which point the energy storage facility is full and can store no further energy.

The amount of energy that an energy storage facility can store is the capacity of the energy storage facility. Because of this finite capacity, the energy input and output into the energy storage facility (i.e., the energy stored and produced by the facility) must be balanced over a certain period of time. To ensure that the energy storage and production of an energy storage facility is balanced, a dispatch plan for a period of time will be produced. This plans the net energy output of the energy storage facility, comprising when and how much energy will be stored, and when and how much energy will be produced.

This dispatch plan, or planned net energy output, will be based on a forecast energy demand value for the time covered by the dispatch plan, often broken down into discreet time periods (e.g., of 15, 30 or 60 minutes in duration). When the energy demand value is forecast to be low, the energy storage facility can plan to store energy as the low demand indicates an excess of electricity on the grid. Conversely, when the energy demand value is forecast to be high, the energy storage facility can plan to produce energy as the high demand indicates that the grid requires additional electricity.

However, the forecast energy demand value for a given period of time may differ from an actual energy demand value. In this case, it is desirable to be able to make an adjustment to the dispatch plan to better align the net energy output with the actual energy demand value.

The present invention provides a method for controlling an energy storage facility as defined in the appended independent claims, to which reference should now be made. Preferred or advantageous features are set out in dependent claims.

According to a first aspect, the present invention provides a method for controlling an energy storage facility. The method comprises: receiving a planned net energy output for a current time period based on a forecast energy demand value for the current time period; receiving a current energy demand value for the current time period; receiving a future energy capacity table comprising, for each of a plurality of future time periods, a forecast energy demand value and a planned net energy adjustment capacity; determining a difference between a current energy demand value and a forecast energy demand value for the current time period; and determining an adjustment to the planned net energy output for the current time period based on the difference between the current energy demand value and the forecast energy demand value for the current time period and the future energy capacity table.

Because of the finite capacity of an energy storage facility, any adjustment to the planned net energy output at one point in time must be balanced out by adjustments at other points in time. Utilising a future energy capacity table enables time periods that can balance out an adjustment to the planned net energy output for a current time to be quickly and easily identified. Furthermore, adjustments are only desirable when doing so would make better use of the energy storage facility to store excess energy when demand is low and provide energy when demand is high. That is, a comparison should be made between the forecast and actual current energy demand value to determine if an adjustment to the planned net energy output would be beneficial, as well as the forecast future energy demand value for a time period with capacity to make a balancing adjustment. This is also easily achieved through the use of the future energy capacity table. Accordingly, the present invention provides a method that enables adjustments to be made to a present energy output whilst ensuring that these can be balanced against adjustments at future time periods and that these adjustments will be beneficial.

Optionally, determining an adjustment to the planned net energy output for the current time period may comprise determining an increase in the planned net energy output for the current time period when the current energy demand value is greater than the forecast energy demand value for the current time period. Alternatively, or in addition, determining an adjustment to the planned net energy output for the current time period may comprise determining a decrease in the planned net energy output for the current time period when the current energy demand value is less than the forecast energy demand value for the current time period.

Decreasing the net energy output when the current energy demand value is lower than the forecast energy demand value for the current time period, or increasing the net energy output when the current energy demand value is greater than the forecast energy demand value for the current time period, means that the energy storage facility can better meet the needs of the energy grid by responding to unforeseen changes of energy demand.

The method further may comprise determining an adjustment to a planned net energy output for one or more of the plurality of future time periods such that the sum of the adjustments in planned net energy output for the current time period and for the plurality of future time periods is zero.

Determining an adjustment to the planned net energy output for future time periods in this manner ensures that the energy storage facility will operate within its capacity and will be able to fulfil the planned net energy output.

In some cases, the adjustment to the planned net energy output for the plurality of future time periods can be made by selecting one or more future time periods from the future energy capacity table having a suitable planned net energy adjustment capacity. In this way, the future energy capacity table can provide a quick and straightforward way to identify when an adjustment can be made in the future to balance out an adjustment made to the current planned output.

Optionally, the plurality of future time periods in the future energy capacity table are ordered by their respective forecast energy demand values. Ordering the plurality of future time periods in this manner can make it very quick to determine whether a future time period exists that meets the criteria for balancing an adjustment made at a current time.

Furthermore, successive adjustments can be made by working through the ordered table. Optionally, determining an adjustment to the planned net energy output for the plurality of future time periods may comprise selecting, when the current energy demand value is greater than the forecast energy demand value for the current time period, one or more future time periods from the plurality of future time periods for which the current energy demand value is greater than the forecast energy demand value for those time periods and determining an adjustment to the planned net energy output for those one or more future time periods. Preferably, the adjustment to the planned net energy output comprises an increase to the planned energy storage and/or a decrease to the planned energy production in the selected future time period(s).

When the current energy demand value is greater than the forecast energy demand value, this indicates that the electricity grid will benefit from additional electricity being fed into it. To balance an adjustment increasing the current net energy output, energy should be “taken” from a future time period that is expected to have less demand, i.e., a lower forecast energy demand value. This balancing is done by increasing the planned energy storage or decreasing the planned energy production at this future time period, so that the current increase in output is balanced by a future increase in input.

Similarly, determining an adjustment to the planned net energy output for the plurality of future time periods may comprises, in addition or alternatively, selecting, when the current energy demand value is less than the forecast energy demand value for the current time period, one or more future time periods from the plurality of future time periods for which the current energy demand value is less than the forecast energy demand value for those time periods and determining an adjustment to the planned net energy output for those one or more future time periods. Preferably, the adjustment to the planned net energy output comprises an increase to the planned energy production and/or a decrease to the planned energy storage in the selected future time period(s).

When the current energy demand value is less than the forecast energy demand value, this indicates that the electricity grid is in less need of electricity, and this energy may be more useful at a later point in time. To balance an adjustment decreasing the current net energy output, energy should be “given” to a future time period that is expected to have greater demand, i.e., a greater forecast energy demand value. This balancing is done by increasing the planned energy production or decreasing the planned energy storage at this future time period, so that the current decrease in output is balanced by a future increase in output.

In some cases, the future energy capacity table may comprise a first table-portion and/or a second table-portion. The first table-portion may comprise the future time periods having positive net energy adjustment capacity ordered by energy demand. The second table-portion may comprise the future time periods having a negative net energy adjustment capacity, ordered by energy demand. In this way, it is immediately apparent from the future energy capacity table in which future time periods net energy output can be increased and in which future time periods net energy output can be decreased.

When such table-portions are implemented, future time periods may be selected for making an adjustment to increase the planned net energy output from the first table-portion in descending order of forecast energy demand. Similarly, future time periods may be selected for making an adjustment to decrease the planned net energy output from the second table-portion in ascending order of forecast energy demand. In this way, sequential adjustments can be made and each of these can be balanced in turn against adjustments made to future time periods.

Optionally, when the planned net energy output of one or more of the plurality of future time periods is to be increased, an adjustment is made to the future time period in the first table-portion having the highest forecast energy demand first. Similarly, when the planned net energy output of one or more of the plurality of future time periods is to be decreased, an adjustment is made to the future time period in the second table-portion having the lowest forecast energy demand first.

In this way, adjustments to the planned net energy output of future time periods can be made in the order that is most beneficial (e.g., when the grid is expected to have the most excess energy, or require additional energy the most).

Optionally, the energy demand values are a residual load value for an electricity grid or are based on the residual load of an electricity grid. This is beneficial as it reflects the demand of the grid that is not being met by renewable energy sources, such as solar and wind, that are not dispatchable. This provides a good indication of the demand for additional energy on top of that provided by such renewable energy sources, that can, in part, be met by energy storage facilities.

Optionally, each energy demand value comprises an efficiency modifier. Preferably, the efficiency modifier is different for energy storage and energy production. Preferably, the efficiency modifier is negative for energy production and positive for energy storage. The efficiency modifier reflects the fact that energy storage facilities are not one hundred percent efficient, and so some energy will be lost both in storing energy and when producing energy. By using an efficiency modifier, this can be accounted for when determining whether an adjustment would be beneficial.

Optionally, each forecast energy demand value comprises an uncertainty modifier. Preferably, the uncertainty modifier is negative for energy production and positive for energy storage. The uncertainty modifier reflects the fact that the actual energy demand value may differ from the forecast energy demand value. By using an uncertainty modifier, the likelihood of an adjustment being made to a future time period that turns out to not be beneficial (because the actual energy demand has differed from the forecast energy demand) can be reduced.

In some instances, receiving a future energy capacity table comprises generating the future energy capacity table. Alternatively, the future energy capacity table may be generated according to the follow steps independently of the operation of an energy storage facility.

In either case, generating the future energy capacity table can comprise: receiving a forecast energy demand value for each of the plurality of future time periods; receiving a planned net energy adjustment capacity for each of the plurality of future time periods; and ordering the plurality of future time periods by forecast energy demand value.

The planned net energy adjustment capacity for each of the plurality of future time periods may be based on one or more of a planned energy production, a planned excess energy production capacity, a planned energy storage, and a planned excess energy storage capacity.

Optionally, generating the future energy capacity table may also comprise generating a first table-portion comprising the future time periods having positive net energy adjustment capacity ordered by energy demand. In addition or alternatively, generating the future energy capacity table may comprise generating a second table-portion comprising the future time periods having a negative net energy adjustment capacity ordered by energy demand.

Generating the first or second table-portions, or both, enables a quick selection of a future time period for which the planned net energy output can be adjusted to balance an adjustment in the current time period. The table-portions in particular make it easy to select an appropriate future time period for adjustment regardless of whether the net energy output of the current time period is to be increased or decreased.

Optionally, the plurality of future time periods can be time periods during a consecutive day following a current day. That is, the future time periods can be periods tomorrow, when the current time period is a period today. The current time period and plurality of future time periods need not be consecutive time periods (i.e., there may be a temporal gap between the current time period and the earliest of the future time periods). In this manner, adjustments made to net energy output on a current day (i.e., today) can be balanced tomorrow, over a short term of a day, ensuring that the energy storage facility does not run the risk of operating outside of its capacity.

Optionally, each time period spans one of 2 hours, 1 hour, 30 minutes, 15 minutes, and 5 minutes. The duration of the time periods may depend on factors such as the responsiveness of the energy storage facility (i.e., how much the energy storage facility can increase or decrease its energy production or storage over a given period of time), how the electricity grids are managed, and so on. The method is particularly beneficial when the time periods are relatively short, such as 30 minutes or less. This is because there is less time to determine whether an adjustment to the net output of a current time period can be balanced with an adjustment to the net output of future time periods in a manner that is overall beneficial to the electricity grid.

In some cases, every time period (i.e., the current time period and each of the plurality of future time periods) may be equal (i.e., the same duration). In other cases, however, this may not be the case. The current time period may have a first duration, and each of the plurality of future time periods may have a second duration. The first duration may be less than the second duration, or the it may be greater. In some cases, the plurality of future time periods may themselves also not all have the same duration.

Optionally, the method may further comprise operating an energy storage facility to produce energy or store energy based on the planned net energy output and the adjustment to the planned net energy output for the current time period.

Optionally, the energy storage facility is a compressed air energy storage facility. In other cases, the energy storage facility may be a pumped hydroelectric energy storage facility, a hydrogen energy storage facility or a liquid air energy storage facility. In some cases, different forms of energy storage may be combined. For example, a compressed air energy storage facility may also store some energy as hydrogen through water electrolysis. This hydrogen may then be burned to heat the air when it is extracted from the compressed air facility to more efficiently extract the potential energy from it.

According to a second aspect, the present invention provides a computer program that, when executed on one or more computing devices, is configured to cause the one or more computing devices to perform the method of the first aspect.

According to a third aspect, the present invention provides a non-transitory memory having stored thereon the computer program of the second aspect.

Any feature in one aspect of the invention may be applied to other aspects of the invention, in any appropriate combination. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE FIGURES

Embodiments of the invention will now be further described by way of example only and with reference to the accompanying figures in which:

FIG. 1 illustrates an energy storage facility dispatch plan;

FIG. 2 illustrates a method according to aspects of the invention;

FIG. 3A illustrates future energy capacity table;

FIG. 3B illustrates a planned energy production table;

FIG. 3C illustrates a planned energy storage table;

FIG. 4 illustrates balancing adjustments to an energy storage facility dispatch plan;

FIG. 5 illustrates an updated energy storage facility dispatch plan; and

FIG. 6 illustrates a method according to aspects of the invention.

Like reference numbers are used for like elements throughout the description and figures.

### DETAILED DESCRIPTION OF THE INVENTION

An energy storage facility stores excess energy from a grid, usually when there is excess electrical power being produced, so that it can be put back onto the grid at a later time when there is a demand for more power.

To operate an energy storage facility, a plan of when energy is to be extracted from a grid, or electrical network, and when energy is to be fed back into the grid is needed. This planned net energy output is known as a dispatch plan. The planned net energy output comprises a planned energy production (i.e., outputting energy from the energy storage facility to the grid) and a planned energy storage (i.e., inputting energy to the energy storage facility from the grid). One of the primary uses of energy storage facilities is to store excess energy when there is high energy production and/or low demand and then feed this stored energy back into the grid when there is low energy production and/or high demand. Therefore, a dispatch plan for an energy storage facility typically comprises planned energy storage during periods of expected high production and/or low demand and planned energy production during periods of expected low production and/or high demand.

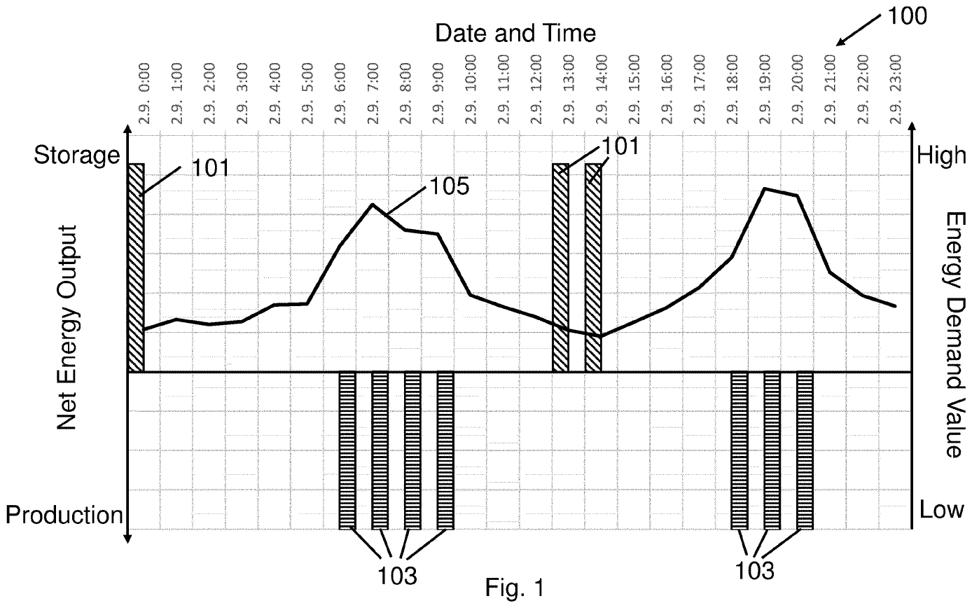

FIG. 1 illustrates an exemplary dispatch plan 100. Dispatch plan 100 covers a time period of one day (in this case 2^{nd} September), which is divided into a plurality of one hour time periods. Each of the plurality of time periods may have a planned energy storage 101 and/or planned energy production 103. For example, there is planned energy storage at 00:00, 13:00, and 14:00 and planned energy production at 06:00, 07:00, 08:00, 09:00, as well as at 18:00, 19:00, and 20:00.

Superimposed over dispatch plan 100 is line 105, illustrating how the energy demand value varies throughout the day covered by the dispatch plan. The energy demand value represents the supply and demand of electrical energy on the grid, as discussed elsewhere in this application. In general, a higher value indicates that the grid is in greater need of electrical power whereas a lower value indicates that the grid is in less need of electrical power. As can be seen comparing line 105 with the planned energy storage 101 and production 103 of dispatch plan 100, when the energy demand value is low, energy storage 101 is typically planned, and when the energy demand value is high, energy production 103 is typically planned.

The dispatch plans, or planned net energy outputs for given time periods, are generated in advance of the period of time (e.g., the day) that they cover. As the actual amount of energy being produced and the energy demand cannot be known for a future point in time, the planned net energy output is based on forecast energy demand and production for the time periods covered by the dispatch plan. The balance between energy demand and production can be represented by an energy demand value, and so the dispatch plans can be based on the forecast energy demand values. These forecast energy demand values will be based on a number of factors, such as the weather (affecting how much renewable energy will be generated), time of year (affecting energy used for heating), day of the week, time of the day, and any other relevant, known factors. However, because the dispatch plans are based on forecast energy demand values, an actual energy demand value during a time period, when that time period becomes the current time period, may differ from the expected energy demand value.

These differences can lead to a less efficient operation of an energy storage facility, as it means that energy may not be produced when is actually needed the most (rather than expected to be needed the most) and may not be stored when it is actually needed the least (rather than expected to be needed the least). Therefore, it is beneficial to be able to make adjustments to the planned net energy output when the current energy demand value differs from the forecast energy demand value for the current period.

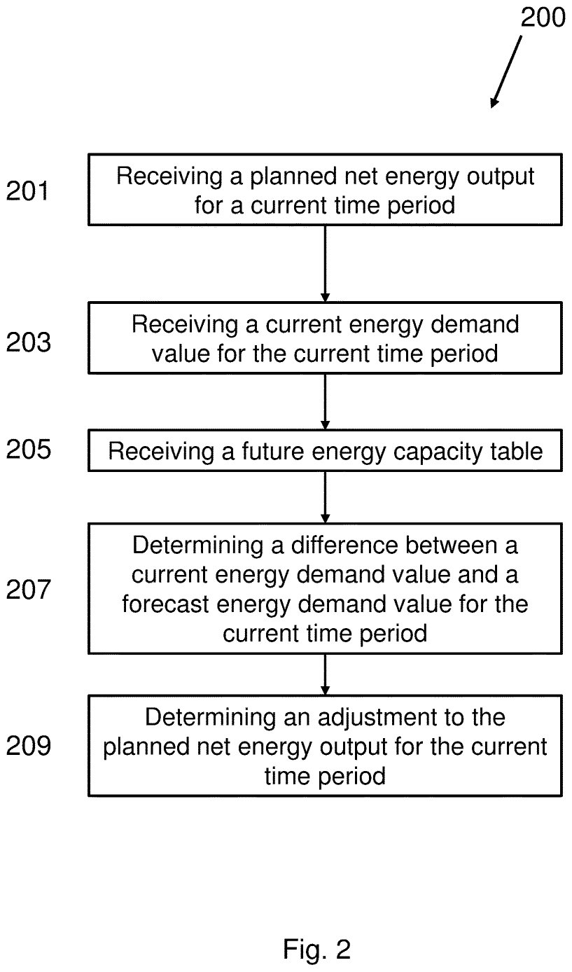

FIG. 2 is a flow diagram illustrating a method 200 of determining an adjustment to the planned net energy output of an energy storage facility. Method 200 begins at step 201 of receiving a planned net energy output for a current time period. This may be in the form of a dispatch plan, such as dispatch plan 100, and preferably comprises a planned energy production and a planned energy storage for the current time period. The planned net energy output for the current time period is based on a forecast energy demand value for the current time period, and may include the forecast energy demand value for the current time period.

At step 203, a current energy demand value for the current time period is received. This is an energy demand value representative of the energy load and the energy generation of the grid at a present time. It is preferably in substantially real time. This energy demand value may correspond to a period of time, such as a 15 minute period, during which the current time falls. After this time period, the next time period will be the new current time period.

A future energy capacity table is received at step 205. The future energy capacity table comprises information relating to a plurality of future time periods. In particular, for each of the plurality of future time periods, the future energy capacity table comprises a forecast energy demand value and a planned net energy adjustment capacity. The entries in the future energy capacity table (i.e., the plurality of future time periods) are preferably ordered based on their forecast energy demand values. By “planned net energy adjustment capacity”, it is meant by how much the energy storage facility could change it's net energy output, by increasing or decreasing it's energy production or energy storage.

At step 207, the current energy demand value and the forecast energy demand value for the current time period are compared and any difference between them is determined. If there is no difference between them, or if the difference is less than a threshold amount (which may be an absolute difference, or a relative amount, such as 5%), then it may be determined that no adjustment to the planned net energy output for the current time period is required and the method can end for the current time period. When the current time period ends, and the subsequent time period becomes the new current time period, the method may be repeated by going back to step 201. On the other hand, when a difference is determined between the current energy demand value and a forecast energy demand value for the current time period (or a difference greater than a threshold difference), the method may progress to step 209.

This step, step 209, comprises determining an adjustment to the planned net energy output for the current time period. Determining this adjustment is based on the difference between the current energy demand value and the forecast energy demand value for the current time period, determined at step 207, as well as the future energy capacity table.

It is worth mentioning that the adjustments performed by the method should change the net energy output in line with the actual needs of the grid at the current time. Preferably, when the current energy demand value is greater than the forecast energy demand value, an increase is made to the planned net energy output for the current time. This is because the planned net energy output was set based on an expectation that the energy demand value of the grid would be lower than it actually is, and so it would be beneficial to increase the net energy production. Conversely, when the current energy demand value is less than the forecast energy demand value, a decrease is preferably made to the planned net energy output for the current time. This is because the planned net energy output was based on an expectation that the energy demand value of the grid would be higher than it actually is, and so more energy production was planned than is actually needed.

It will be appreciated that the steps of method 200 need not necessarily be performed in the order presented in FIG. 2. For example, steps 201, 203 and 205 may be performed in any order, or even simultaneously. Generally, the only requirements are that steps 201 and 203 are performed before step 207, and that steps 205 and 207 are performed before step 209.

Because an energy storage facility has a finite capacity, to both store energy from the grid and produce energy for the grid, the energy production of the energy storage facility should be balanced by the energy storage of the energy storage facility. This is taken into account when planning the energy production and storage schedules of the dispatch plans. It is also preferable that any adjustments to the net energy output planned for the current time period are also balanced. Generally speaking, an adjustment to the net energy output at the current time period must be balanced by an adjustment to the net energy output at a future time period. If the net energy output is to be increased at the current time period then the net energy output must be reduced at a future time, and, conversely, if the net energy output is to be reduced at the current time period then the net energy output must be increased at a future time.

The planned net energy output of the energy storage facility can be increased by either decreasing the planned energy storage, increasing the planned energy production, or a combination of the two. Similarly, the planned net energy output of the energy storage facility can be decreased by either increasing the planned energy storage, decreasing the planned energy production, or a combination of the two.

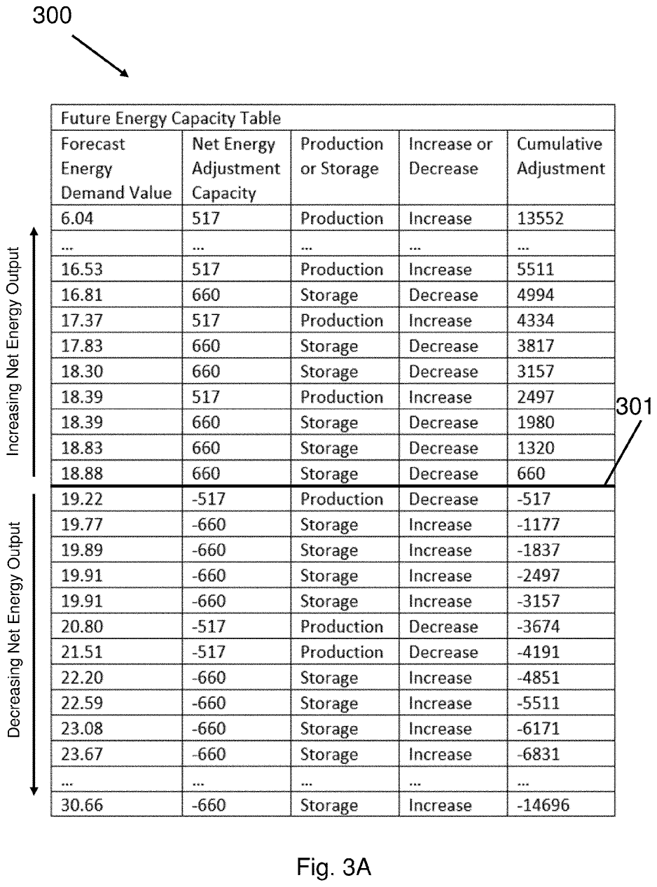

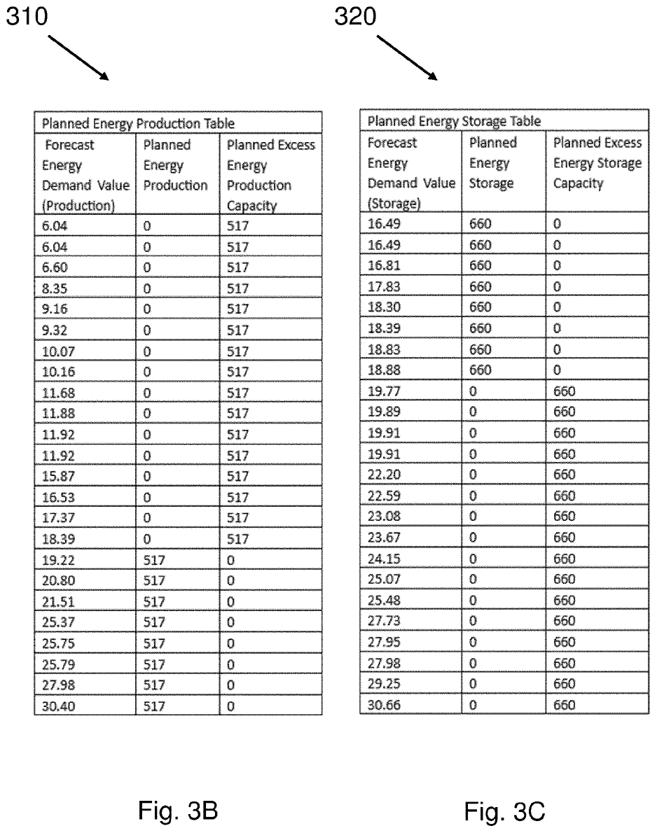

A future energy capacity table makes it easy to balance an adjustment in the planned net energy output for the current time period by providing immediate access to future time periods during which a balancing adjustment can be made to the planned net energy output for the future time periods. An exemplary future energy capacity table 300 is shown in FIG. 3A. Future energy capacity table 300 comprises a list of the possible adjustments that can be made to the net energy output for a plurality of future time periods. In the present example, there are 24 future time periods, each one hour long and spanning a day. In practice, this day will often be the next day after the current day (i.e., tomorrow). It is noted, however, that the time periods to which each row correspond are not illustrated in FIG. 3A. This is because, for the reasons discussed below, the time periods are preferably identified by their forecast energy demand value. However, a correspondence must still be maintained between each time period and the actual time to which it corresponds (so that a determined adjustment can be made to the correct time period), and in some cases this can be done within the future energy capacity table.

As indicated, each of the plurality of future time periods has an associated forecast energy demand value. Furthermore, each of the plurality of future time periods has an associated planned energy production, planned excess energy production capacity, planned energy storage, and planned excess energy storage capacity. These are illustrated in FIGS. 3B and 3C. FIG. 3B illustrates the planned energy production and the planned excess energy production capacity in table 310, whilst FIG. 3C illustrates the planned energy storage and the planned excess energy storage capacity in table 320. It can be seen that both table 310 and table 320 comprise 24 rows, one row corresponding to each of the plurality of future time periods. However, as with the future energy capacity table 300, the actual time period corresponding to each row is not illustrated, though again, this correspondence must be maintained.

Looking at tables 310 and 320, it can be seen that the forecast energy demand values are different for energy production 310 and energy storage in table 320. This reflects that different factors affect energy production and energy storage. For example, energy storage and energy production will both utilise processes that are not one hundred percent efficient (that is, some energy will be lost when storing energy, as well as producing energy by retrieving it from storage). However, the inefficiencies for energy storage and energy production will often be different, because the physical processes for storing energy and producing energy are different. To account for these inefficiencies, an efficiency modifier may be incorporated into the forecast energy demand value. This efficiency modifier may be negative for energy production and positive for energy storage. A negative efficiency modifier for energy production means that the energy storage facility will be operated to produce energy only when there is enough of a demand to overcome the losses during energy production, while a positive efficiency modifier for energy storage means that the energy storage facility will be operated to store energy only when there is enough excess energy to overcome the losses during energy storage.

Similarly, because the forecast energy demand values are only predictions, and hence may change, an uncertainty modifier can also be incorporated into the forecast energy demand values. This means that the energy storage facility will be operated only when there is a relative level of confidence that it will be beneficial to do so. As with the efficiency modifier, the uncertainty modifier may be negative for energy production and positive for energy storage. The larger the uncertainty modifier, the less likely it will be that the planned energy storage or planned energy production will actually turn out to not be beneficial. On the other hand, a large uncertainty modifier also means that the energy storage facility will be less responsive to the needs of the grid, and only store energy when there is a large excess and only produce energy when there is a large demand. A smaller uncertainty modifier will enable the energy storage facility to balance out the smaller energy excesses and increases in energy demand of the grid.

The future energy capacity table 300 may be generated by essentially combining the planned energy production table 310 and the planned energy storage table 320. The factors discussed above, however, mean that, for each of the plurality of future time periods, there may be two forecast energy demand values-one for energy production and one for energy storage. The future energy capacity table 300, therefore has 48 rows. This corresponds to two rows for each time period: one row for the energy production during that time period and one row for the energy storage at that time period. It is noted, however, that in FIG. 3 not all of the rows of table 300 are illustrated for clarity, with missing rows being represented by rows containing ellipses.

When combining the planned energy production table 310 and the planned energy storage table 320 to generate the future energy capacity table 300, the planned energy production, planned excess energy production capacity, planned energy storage and planned excess energy storage capacity for each time period are replaced by a planned “net adjustment capacity”. This represents how the energy storage facility can vary it's net energy output by adjusting the planned energy storage and energy production for each time period. A planned energy production (e.g., in the row with forecast energy demand value 19.22 in planned energy production table 310) corresponds to a negative net adjustment capacity, as the net energy output of the energy storage facility can be decreased by reducing the energy production at that time period. A planned excess energy production capacity (e.g., in the row with forecast energy demand value 18.39 in planned energy production table 310) corresponds to a positive net adjustment capacity, as the net energy output of the energy storage facility can be increased by increasing the energy production at that time period. A planned energy storage (e.g., in the row with forecast energy demand value 18.88 in planned energy storage table 320) corresponds to a positive net adjustment capacity, as the net energy output of the energy storage facility can be increased by reducing the energy storage at that time period. A planned excess energy storage capacity (e.g., in the row with forecast energy demand value 19.77 in planned energy storage table 320) corresponds to a negative net adjustment capacity, as the net energy output of the energy storage facility can be decreased by increasing the energy storage at that time period.

Preferably, the rows of the future energy capacity table are ordered in order of their forecast energy demand value. As can be seen, this will lead to a mixing of forecast energy demand values corresponding to energy storage and energy production. It will also lead to a mixing of forecast energy demand values at different times, such that they are not in chronological order.

When the forecast energy demand value is low, energy storage is typically planned whilst energy production is not planned. This leads to an overall negative planned net energy output for time periods having low forecast energy demand values, allowing adjustments to increase the planned net energy output to be made during these time periods.

Correspondingly, when the forecast energy demand value is high, energy production is typically planned whilst energy storage is not planned. This leads to an overall positive planned net energy output for time periods having high forecast energy demand values, allowing adjustments to decrease the planned net energy output to be made during these time periods.

At an intermediate value, a transition will occur. This transition is represented by line 301 in FIG. 3A. This line 301 divides the future energy capacity table into two table-portions. The top part of the table is a first table-portion, and comprises all of the future time periods having a positive net energy adjustment capacity. The bottom part of the table is a second table-portion, and comprises all of the future time periods having a negative net energy adjustment capacity. That is, time periods having a forecast energy demand value lower than the value at the transition line 301 will have capacity for an adjustment to increase the net energy production of the energy storage facility. This can be done either by decreasing the planned energy storage during time periods having a planned energy storage or by increasing the planned energy production during time periods having spare capacity for energy production. Conversely, time periods having a forecast energy demand value higher than the value at the transition line 301 will have capacity for an adjustment to decrease the net energy production of the energy storage facility. This can be done either by increasing the planned energy storage during time periods having spare capacity for storing extra energy or by decreasing the planned energy production during time periods having a planned energy production. These options are illustrated by the third and fourth columns of the future energy capacity table, which are included for illustrative purposes but need not form part of an actual future energy capacity table during use.

Using the future energy capacity table, it is, therefore, easy to select a future time period that has the capacity to accept a balancing adjustment to it's planned net energy output. In some cases, an adjustment to the planned net energy output of the current time may be balanced not by an adjustment to the planned net energy output of just one future time period, but by adjustments to a number of future time periods. In this case, each of the future time periods may have the same adjustment made to it's planned net energy output, or different future time periods may have different adjustments made to their planned net energy outputs. If adjustments are to be made to the net energy output of a plurality of future time periods, then this is preferably done in order of the forecast energy demand of the future time periods. If the planned net energy output of a plurality of future time periods is to be increased, an adjustment is made to the future time period in the first table-portion having the highest forecast energy demand value first and then to future time periods descending down through the time periods having progressively lower forecast energy demand values. Conversely, if the planned net energy output of a plurality of future time periods is to be decreased, an adjustment is made to the future time period in the second table-portion having the lowest forecast energy demand first and then to future time periods ascending up through the time periods having progressively higher forecast energy demand values. In each case, the initial future time period to which an adjustment is made is the one directly above or below the transition line 301. A cumulative adjustment column can be provided in the future energy capacity table, as illustrated in FIG. 3A, to enable a quick determination of how many and which future time periods will need to have their net energy output adjusted in order to obtain a required balancing adjustment.

In some cases, the method may include determining a balancing adjustment to the planned net energy output of one or more of the plurality of future time periods by selecting one or more future time periods from the future energy capacity table having a planned net energy adjustment capacity and determining an adjustment to the planned net energy output of the selected one or more future time periods. Again, as noted above, when adjustments are made to the planned net energy output of more than one future time period, the adjustments made to the planned net energy outputs of each of these future time periods need not be the same.

A balancing adjustment will only be beneficial, however, if the proposed net change in output power now and the proposed net change in power output at the future time period together meant that the net energy output of the energy storage facility better meets the need of the grid. That is, whilst an adjustment to the net energy output of a current time period may mean that the energy storage facility is better meeting the demands of the grid at the current time, if a balancing adjustment to the net energy output of a future time period means that at that future time period the energy storage facility will not meet the (expected) demands of the grid as well, it may in fact be preferable not to make either the adjustment to the net energy output of the current time period or the adjustment to the net energy output of the future time period. This may be the case even if this means that the net energy output of the energy storage facility is not optimised for the current time, as it will instead be better optimised over a greater time period. This may also be the case even when future time periods have capacity to physically make an adjustment to their net energy output.

The planned net energy output of an energy storage facility, such as in the form of a dispatch plan, will often be optimised over an extended period of time (such as a day or week, comprising a plurality of periods of time within that extended period having planned energy production and storage) based on the forecast energy demand values during that extended period of time. Therefore, making an adjustment to the planned net energy output for a future time period may result in making the planned net energy output at that time less optimised for that future time period. As such, it is beneficial to compare potential adjustments to the planned net energy output for future time periods with a possible adjustment to the planned net energy output for the current time period to check whether the overall effect of both adjustments (i.e., the adjustments to the planned net energy output for the current time period and a future time period) is beneficial.

This can be done by using the energy demand values. Generally speaking, the higher an energy demand value, the more the grid requires energy. Conversely, the lower an energy demand value, the less the grid requires energy. Overall, if an increase to the net energy output now is balanced by a decrease to the net energy output at a time period having a lower energy demand value than the energy demand value of the current time, then this will be beneficial. Similarly, if a decrease to the net energy output now is balanced by an increase to the net energy output at a time period having a higher energy demand value than the energy demand value of the current time, then this will be beneficial. In both cases, it can be thought of as moving energy in time from when there is less demand to when there is more demand.

Turning again to the illustrative future energy capacity table 300 of FIG. 3, it can be seen that this table comprises the forecast energy demand values of each of the plurality of future time periods. Hence, when it is determined that an adjustment can be made to the net energy output of the current time period, the future energy capacity table 300 can be consulted and a future time period having both the net energy adjustment capacity for a balancing adjustment as well as a suitable forecast energy demand value can be selected. In particular, when the current energy demand value is greater than the forecast energy demand value for the current time period, the method can comprise selecting one or more future time periods from the plurality of future time periods for which the current energy demand value is greater than the forecast energy demand value for those one or more future time periods and determining an adjustment to the planned net energy output for those one or more future time periods. This adjustment can be an increase to the planned energy storage for the one or more future time periods or a decrease to the planned energy production for the one or more future time periods (or some combination thereof), balancing out an adjustment to increase energy production for the current time period or a decrease in energy storage for the current time period (or some combination thereof).

Similarly, when the current energy demand value is less than the forecast energy demand value for the current time period, the method can comprise selecting one or more future time periods from the plurality of future time periods for which the current energy demand value is less than the forecast energy demand value for those time periods and determining an adjustment to the planned net energy output for those one or more future time periods. This adjustment can be an increase to the planned energy production for the one or more future time periods or a decrease to the planned energy storage for the one or more future time periods (or some combination thereof), balancing out an adjustment to increase energy storage for the current time period or reduce energy production for the current time period (or some combination thereof). As a general rule, the greater the difference between the current energy demand and forecast energy demand for the future time period, the more beneficial the overall adjustment to the planned net energy output for the current time period and the balancing adjustment to the one or more future time periods will be.

In order to enable a quick assessment of whether a suitable future time period exists for making a balancing adjustment to the planned net energy output based on the forecast energy demand value requirements as discussed above, the future time periods in the future energy capacity table can preferably be ordered by their forecast energy demand value. As noted previously, in future energy capacity table 300, the rows corresponding to each of the plurality of future time periods are not arranged in temporal order, but are instead arranged such that the forecast energy demand values for each of the plurality of future time period are ordered. This enable a quick determination as to whether a future time period exists that meets the requirements for a balancing adjustment.

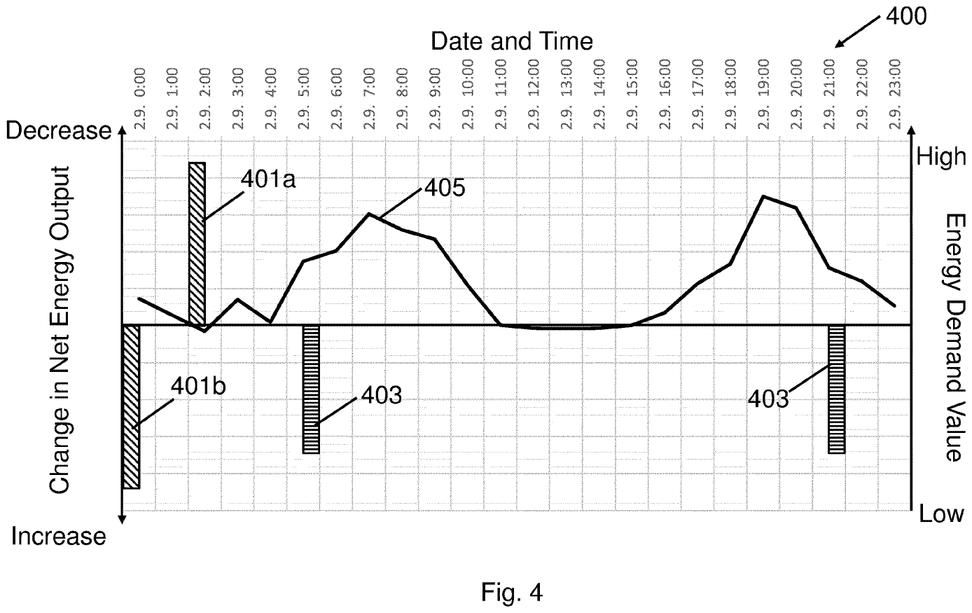

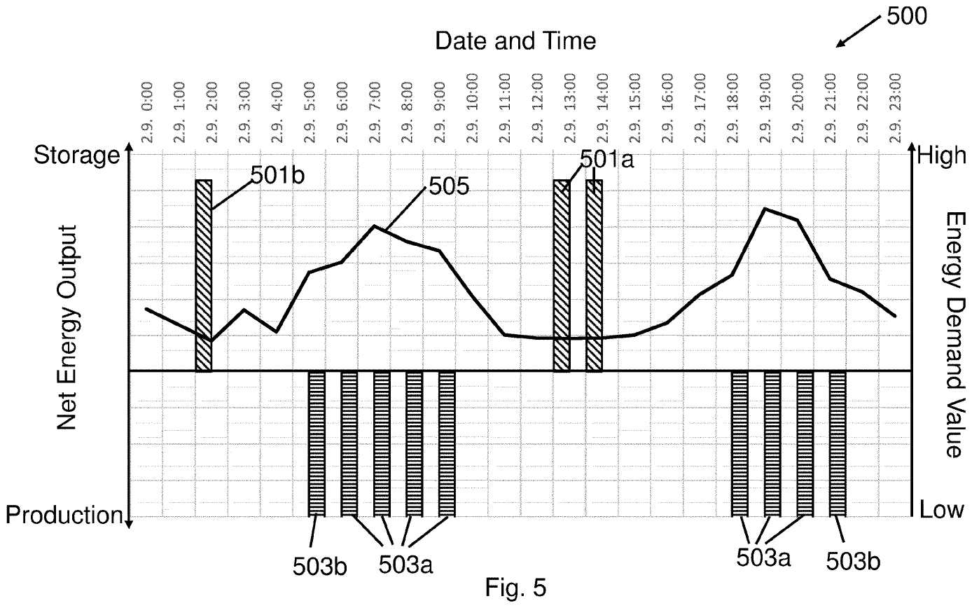

The method of determining adjustments for the current time period and balancing adjustments for one or more future time periods can be repeated for a sequence of successive current time periods. Furthermore, each time a balancing adjustment to one or more future time periods is determined, the future energy capacity table 300 is updated to reflect this. In one example, a current day is divided into 24 one-hour time periods. At each time period, method 200 is performed, leading to adjustments of a number of the time periods throughout the day. An example of these adjustments is illustrated in FIG. 4. This Figure illustrates the actual energy demand 405 throughout the day (as opposed to the forecast energy demand 105 of FIG. 1), and shows the adjustments made to the planned net energy output. Changes to the planned energy storage 401 are illustrated with diagonal shading, whilst changes to the planned energy production 403 are illustrated with horizontal shading.

It is noted that an increase in the net energy output of the energy storage facility is illustrated with a bar extending below the horizontal axis whereas a decrease in the net energy output of the energy storage facility is illustrated with a bar extending above the horizontal axis. Therefore, looking at adjustment plan 400, it can be seen that at 00:00 an adjustment was made to decrease the planned energy storage 401b; at 02:00 an adjustment was made to increase the planned energy storage 401a; and, at 05:00 and 21:00, changes were made to increase the planned energy production 403 of the energy storage facility.

The result of this iterative application of method 200 for subsequent time periods can be seen in FIG. 5. FIG. 5 shows a record of the actual energy production and energy storage throughout the day in this example, i.e., the updated dispatch plan 500 that was implemented by the energy storage facility. It should be noted that whilst being referred to as an updated dispatch plan, this is a record of the energy storage and energy production performed throughout the day, rather than an updated dispatch plan put together before the day.

The actual energy demand value 505 is shown throughout the day, and is the same as shown by line 405 in FIG. 4 rather than by line 105 in FIG. 1, as line 105 was the forecast energy demand value.

The periods of energy storage 501 and energy production 503 are essentially the sum of the original dispatch plan 100 of FIG. 1 and the adjustments to the dispatch plan in adjustment plan 400 of FIG. 4. For example, it can be seen that, compared to the original dispatch plan 100, updated dispatch plan 500 does not comprise any energy storage at 00:00, because this was changed by the adjustment plan 400 (column 401b). Instead, in addition to the originally planned storage 501a at 13:00 and 14:00, updated dispatch plan 500 comprises new energy storage 501b at 02:00. Similarly, in addition to the originally planned energy production 503a at 06:00, 07:00, 08:00, and 09:00, as well as at 18:00, 19:00, and 20:00, present in dispatch plan 100, updated dispatch plan 500 also comprises additional energy production 503b at 05:00 and 21:00, based on the changes implemented in the adjustment plan 400 (columns 403).

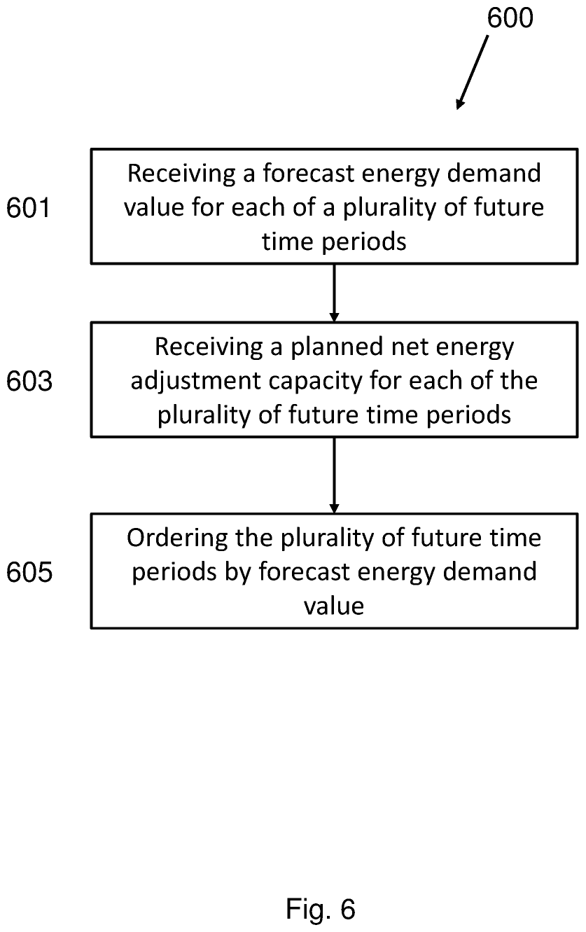

A method 600 of generating a future energy capacity table is illustrated in FIG. 6. This method 600 may be implemented independently to generate a future energy capacity table, which may then be provided to a different party for subsequent implementation to operate an energy storage facility. Alternatively, this method 600 may be implemented during step 205 of method 200, whereby a future energy capacity table is received.

Method 600 begins at step 601, during which a forecast energy demand value for each of a plurality of future time periods is received. As discussed above, each of the plurality of future time periods may in fact have two forecast energy demand values associated with it, one for energy production and one for energy storage, taking into account factors like the inefficiencies in the energy storage facility and the uncertainty in the forecast energy demand values.

At step 603, planned net energy adjustment capacities for increasing and/or for decreasing planned net energy output in each of the plurality of future time periods are received. This may be derived from a planned energy production, a planned excess energy production capacity, a planned energy storage, and a planned excess energy storage capacity, as discussed above and in particular with respect to the planned energy production table 310 of FIG. 3B and the planned energy storage table 320 of FIG. 3C. Preferably, the planned net energy adjustment capacities are presented as in the future energy capacity table 300 illustrated in FIG. 3A.

Then, at step 605, the plurality of future time periods are ordered based on the forecast energy demand values. In this case, and more generally with the methods described herein, if a future time period has two associated forecast energy demand values (a storage energy demand value and a production energy demand value), these may be treated as two separate, independent time periods that correspond to the same period of time during the day. Thus, the future energy capacity table will have twice the number of rows than time periods during the day, as discussed with respect to future energy capacity table 300 of FIG. 3A.

In some implementations, generating the future energy capacity table, and in particular step 605 of ordering the plurality of future time periods based on the forecast energy demand values, may comprise generating a first and/or a second table-portion. The first table-portion can comprise the future time periods having a positive net energy adjustment capacity ordered by energy demand, whilst the second table-portion can comprise the future time periods having a negative net energy adjustment capacity ordered by energy demand, as illustrated in future energy capacity table 300 of FIG. 3A.

It will be understood that the term “storing energy” is intended, unless otherwise stated or clear contextually, to include both the retention of energy in a potential form as well as the act of converting electrical energy into the potential energy. That is, “storing” encompasses taking electrical energy from the grid, converting it into a potential form, and retaining this potential energy. For example, in a compressed air energy storage facility, “storing” includes using electrical energy from the grid to drive one or more compressors to compress air for storing, as well as the act of storing the compressed air.

The term “producing energy” is intended, unless otherwise stated or clear contextually, to include the act of converting stored potential energy into electrical energy and the feeding of this electrical energy into an electricity grid. For example, in a compressed air energy storage facility, “producing” includes releasing compressed air from storage to drive a turbine that generates electrical energy, which is then fed into the grid.

The terms “electricity grid” or “network”, “electrical grid” or “network”, “energy grid” or “network”, or simply “grid” or “network” are generally used interchangeably except when indicated or contextually clear otherwise. The grid or network may be any type of electrical network from which an energy storage facility can extract electrical energy and feed back electrical energy to. It may, for example, be a national or international electrical grid, a private grid, a micro grid and the like.

A useful metric representing an energy demand value, this combination of electricity supply and demand, is residual load. The residual load can be defined as the load remaining on the electrical grid after the contributions from non-dispatchable renewable energy sources (in particular, wind and solar power) have been subtracted. The residual load represents the extra energy that must, therefore, be provided by dispatchable energy sources. A dispatchable energy source is one that can provide energy according to a defined plan, such as a dispatch plan. On the other hand, non-dispatchable energy sources cannot solar power is dependent upon the amount of sunshine and wind power is dependent upon the wind, neither of which can be controlled.

When the residual load is high, this means that there is a large amount of power that must be accounted for by dispatchable means, and when is low then there is little additional power required to be provided by dispatchable means. Therefore, when the residual load is low, it may be a desirable time to store energy with an energy storage facility, and when the residual load is high, it may be a desirable time to generate electricity from the stored energy.

The overall capability of an energy storage facility is defined by the physical capacity of the system, determined by the maximum and minimum amount of potential energy that the energy storage facility can store (i.e., when it is full or empty respectively), as well as the capacity of the energy storage facility to increase or decrease the amount of stored potential energy over a time period (i.e., the “rate capacity”; how much can be stored or produced in the time period). For example, in the case of a compressed air energy storage system, the physical capacity of the system will be defined by the size and configuration of the compressed air storage means, determining how much air can physically be stored within the energy storage facility and at what pressure. This determined the maximum amount of potential energy that the compressed air energy storage system can store. The rate capacity of the compressed air energy storage system will be determined by the compressor trains (for energy storage) and the turbine trains (for energy production). Other factors may also affect this rate capacity, including the amount of potential energy currently stored in the energy storage facility.

Described above are a number of embodiments with various optional features. It should be appreciated that, with the exception of any mutually exclusive features, any combination of one or more of the optional features are possible.

The methods described herein are implemented in a computing environment, for example, on a computing device comprising a processor, a memory for storing data and instructions, an input device such as a mouse and keyboard, and an output such as a screen or monitor. The computing environment may be a cloud based solution or a computer network, and individual computing devices may comprise a plurality of processors, memories, and other components. Furthermore, the computing environment is also preferably connected to one or more networks, such as the internet, to allow for remote access and/or control of the methods, the receiving and sending of data (e.g., transmitting the adjustments resulting from methods described herein to a LDES facility).

1. A method for controlling an energy storage facility, the method comprising:
receiving a planned net energy output for a current time period based on a forecast energy demand value for the current time period;
receiving a current energy demand value for the current time period;
receiving a future energy capacity table comprising, for each of a plurality of future time periods, a forecast energy demand value and a planned net energy adjustment capacity;
determining a difference between the current energy demand value and the forecast energy demand value for the current time period; and
determining an adjustment to the planned net energy output for the current time period based on the difference between the current energy demand value and the forecast energy demand value for the current time period and the future energy capacity table.

2. The method of claim 1, wherein determining an adjustment to the planned net energy output for the current time period comprises:
determining an increase in the planned net energy output for the current time period when the current energy demand value is greater than the forecast energy demand value for the current time period; and/or
determining a decrease in the planned net energy output for the current time period when the current energy demand value is less than the forecast energy demand value for the current time period.

3. The method of claim 1, wherein the method further comprises determining an adjustment to a planned net energy output for one or more of the plurality of future time periods such that the sum of the adjustments in planned net energy output for the current time period and for the plurality of future time periods is zero.

4. The method of claim 3, wherein the adjustment to the planned net energy output for the plurality of future time periods is made by selecting one or more future time periods from the future energy capacity table having a suitable planned net energy adjustment capacity.

5. (canceled)

6. The method of claim 3 wherein determining an adjustment to the planned net energy output for the plurality of future time periods comprises:
selecting, when the current energy demand value is greater than the forecast energy demand value for the current time period, one or more future time periods from the plurality of future time periods for which the current energy demand value is greater than the forecast energy demand value for those time periods and determining an adjustment to the planned net energy output for those one or more future time periods.

7. The method of claim 6, wherein the adjustment to the planned net energy output for the one or more future time periods comprises one or both of an increase to the planned energy storage or a decrease to the planned net energy production for each of the selected one or more future time periods.

8. The method of claim 3 wherein determining an adjustment to the planned net energy output for the plurality of future time periods comprises:
selecting, when the current energy demand value is less than the forecast energy demand value for the current time period, one or more future time periods from the plurality of future time periods for which the current energy demand value is less than the forecast energy demand value for those time periods and determining an adjustment to the planned net energy output for those one or more future time periods, wherein the adjustment to the planned net energy output for the one or more future time periods comprises one or both of an increase to the planned energy production or a decrease to the planned energy storage for each of the selected one or more future time periods.

9. (canceled)

10. The method of claim 1, wherein the future energy capacity table comprises a first table-portion comprising the future time periods having positive net energy adjustment capacity ordered by energy demand; and/or
wherein the future energy capacity table comprises a second table-portion comprising the future time periods having a negative net energy adjustment capacity ordered by energy demand.

11. The method of claim 10, wherein future time periods are selected for making an adjustment to increase the planned net energy output from the first table-portion in descending order of forecast energy demand and/or wherein future time periods are selected for making an adjustment to decrease the planned net energy output from the second table-portion in ascending order of forecast energy demand.

12. The method of claim 11, wherein when the planned net energy output of one or more of the plurality of future time periods is to be increased, an adjustment is made to the future time period in the first table-portion having the highest forecast energy demand first, wherein when the planned net energy output of one or more of the plurality of future time periods is to be decreased, an adjustment is made to the future time period in the second table-portion having the lowest forecast energy demand first.

13. (canceled)

14. The method of claim 1, wherein each energy demand value is a residual load value for an electricity grid or is based on the residual load of an electricity grid.

15. The method of claim 1, wherein each energy demand value comprises an efficiency modifier; wherein optionally the efficiency modifier is negative for energy production and positive for energy storage.

16. The method of claim 1, wherein each forecast energy demand value comprises an uncertainty modifier; wherein optionally the uncertainty modifier is negative for energy production and positive for energy storage.

17. The method of claim 1, wherein receiving a future energy capacity table comprises generating the future energy capacity table, and wherein generating the future energy capacity table comprises:
receiving a forecast energy demand value for each of the plurality of future time periods;
receiving a planned net energy adjustment capacity for each of the plurality of future time periods; and
ordering the plurality of future time periods by forecast energy demand value.

18. (canceled)

19. The method of claim 18, wherein the planned net energy adjustment capacity for each of the plurality of future time periods is based on one or more of a planned energy production, a planned excess energy production capacity, a planned energy storage, and a planned excess energy storage capacity.

20. The method of claim 18 wherein generating the future energy capacity table comprises generating a first table-portion comprising the future time periods having positive net energy adjustment capacity ordered by energy demand.

21. The method of claim 18, wherein generating the future energy capacity table comprises generating a second table-portion comprising the future time periods having a negative net energy adjustment capacity ordered by energy demand.

22. (canceled)

23. The method of claim 1, further comprising operating an energy storage facility to produce energy or store energy based on the planned net energy output and the adjustment to the planned net energy output for the current time period.

24. A computer program that, when executed on one or more computing devices, is configured to cause the one or more computing devices to perform the method of controlling an energy storage facility, the method comprising:
receiving a planned net energy output for a current time period based on a forecast energy demand value for the current time period;
receiving a current energy demand value for the current time period;
receiving a future energy capacity table comprising, for each of a plurality of future time periods, a forecast energy demand value and a planned net energy adjustment capacity;
determining a difference between the current energy demand value and the forecast energy demand value for the current time period; and
determining an adjustment to the planned net energy output for the current time period based on the difference between the current energy demand value and the forecast energy demand value for the current time period and the future energy capacity table

25. A non-transitory memory having stored thereon the computer program of claim 24.
